(19) United States
(12) Patent Application Publication
(10) Pub. No.: US 2017/0243158 A1
(43) Pub. Date: Aug. 24, 2017

(54) ARTICLE COLLATION SYSTEM AND METHOD THEREOF

(71) Applicant: GREY ORANGE INDIA PVT. LTD., Gurgaon, Haryana (IN)

(72) Inventors: Akash GUPTA, Delhi (IN); Samay KOHLI, New Delhi (IN); Srijan CHOUDHARY, Bilaspur (IN); Gaurav KUMAR, Purnia (IN); Gaurav KEJRIWAL, Varanasi (IN); Varundev SOLANKI, Gotri Vadodara (IN); Apurva VADERA, Mumbai (IN); Karan MITTAL, Amritsar (IN)

(73) Assignee: GREY ORANGE INDIA PVT. LTD., Gurgaon, Haryana (IN)

(21) Appl. No.: 15/506,145

(22) PCT Filed: Oct. 15, 2015
(86) PCT No.: PCT/IN2015/000388

§ 371 Date: Feb. 23, 2017

(30) Foreign Application Priority Data
Oct. 22, 2014 (IN) 3014/DEL/2014

(51) Int. Cl. G06Q 10/08; G06Q 50/28

(52) U.S. Cl. CPC G06Q 10/0832; G06Q 50/28

(57) ABSTRACT

Embodiments of the present disclosure refer to an article collation system and method for collating articles where ‘article’ may indicate an object, thing, item, unit, piece of merchandise, commodity, product, good or an entity synonymous with the definition provided. According to an embodiment of the present disclosure, an article collation system comprises at least one identifier associated with each article where one or more attributes are associated with each identifier. Further, the system comprises one or more transporters for moving each article along a common path to one of a plurality of collection points, where a plurality of diverters are associated with one or more said transporters for routing each article to said collection point, and a controller dynamically adapting operation of said transporters and said diverters to fulfill user requirements considering the attributes of each article and optimizing the system functions based on instantaneous load conditions.

### FIELD OF THE DISCLOSURE

The field of the present disclosure pertains to an article collation system and method thereof, and particularly, collation involving combination and/or sortation of articles.

### BACKGROUND

The proliferation of e-Retailing systems covering a very wide range of uniquely different orders involving articles of several different sizes, shapes, weights, packaging and other characteristics such as special handling requirements, coupled with the constant pressure for very quick deliveries, has generated the need for highly flexible, automated/semi-automated “Combining” and “Shipping” systems (collectively termed “Collation systems”) at e-Retailing supplier warehouses. Additional complexities arise from special “priority shipping” requirements associated with specific orders, which need to be processed along with non-priority shipping orders, making the allocation of common items a difficult task. Existing Collation Systems, while providing many of the desired features fail to provide adequate dynamic configurability in a multi-level collation process that is necessary to meet these requirements.

The problems are aggravated by the complexities imposed by two additional factors namely, the constraints imposed by “special” requirements for certain articles (such as special handling procedures), coupled with the unpredictable and sudden “peak load” conditions that occur frequently. Existing systems fall short in terms of efficiency and cost-effectiveness under such highly variable and unpredictable conditions.

### SUMMARY

Embodiments of the present disclosure refer to an article collation system and method for collating articles where ‘article’ may indicate an object, thing, item, unit, piece of merchandise, commodity, product, good or an entity synonymous with the definition provided. According to an embodiment of the present disclosure, an article collation system comprises at least one identifier associated with each article where one or more attributes are associated with each identifier. Further, the system comprises one or more transporters for moving each article along a common path to one of a plurality of collection points, where a plurality of diverters are associated with one or more said transporters for routing each article to said collection point, and a controller dynamically adapting operation of said transporters and said diverters to fulfill user requirements considering the attributes of each article and optimizing the system functions based on instantaneous load conditions.

Another embodiment of the present disclosure refers to a method for collating articles comprising associating at least one identifier with each article, associating one or more attributes with each identifier, moving each article along a common path to one of a plurality of collection points using one or more transporters, routing each article to said collection point using a plurality of diverters associated with one or more of said transporters and adapting dynamically operation of said transporters and said diverters to fulfill user requirements considering the attributes of each article and optimizing the system functions based on instantaneous load conditions.

According to exemplary embodiments of the present disclosure, collation system encompasses all aspects of an article combination and/or sortation system. In the instance, the collation system operates as a combination system, articles placed on the transporter are combined based on user requirements and orders placed by respective users to provide a combined order. In such a scenario, the collection points are specific to an order placed. The combined order is tagged in manner to identify delivery details of the order, service provider details for handling the order(s) besides any specific order handling procedure. In the instance, the system operates as a sortation system; orders are sorted at a single or multi level for an organized and efficient delivery of said orders. In such a scenario, orders with tags are diverted to collection points based on delivery details of said orders or service provider details. According to an embodiment, orders are accumulated at each collection point in a bag, where each bag has a unique seal tag placed upon sealing the bag. The collection point may indicate the need to seal a bag via a Put To Light mechanism using a Pick Put to Light (PPTL), where each PPTL is identified by a particular barcode. The PPTL blinks upon the need to seal a bag based on instances where the bag is full with articles or the bag is required for delivery based on the special handling requirements. Upon indication of the need to close the bag, the barcode of the PPTL and the seal tag of the bag are scanned to generate a manifest indicating attributes of every article in the sealed bag. The manifest therefore, indicates any special handling requirements of the sealed bag besides the categories of the articles within the sealed bags.

According to an exemplary embodiment of the present disclosure, the step of adapting dynamically operation of said transporters and said diverters comprises checking logs for load conditions and extracting load parameters in a defined time interval at all collection points. Collection points where load is above a threshold value are determined based on the extracted load parameters and the determined collection points are reassigned to optimize load distribution and handling. In an embodiment of the present application, load parameters may include peak load, mean load and in the instance of operation of the collation system as a sortation system, the bag closing activity is also taken into account.

In an embodiment of the present disclosure, identifiers may refer to a barcode or a tag identifying the contents of a particular article. Further, the attributes associated with each identifier may provide information regarding the length, breadth and height of the article. The attributes may also include weight of the article, which may be identified based on load cells of an article.

According to an embodiment of the present disclosure, the transporter utilizes plurality of conveyor belts to form a common path, where the common path may comprise a sensor at conjunction of two conveyor belts to evaluate the article on the path. In an embodiment, the controller adjusts the spacing of articles on the transporter to ensure sensing of the article by the sensor on the common path.

In another embodiment of the present disclosure, each collection point scans a diverted article to ascertain accuracy of collation. If an article is not intended for the collection point, it blinks to relay the incorrect collation.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a block diagram representation of an article collation system according to an embodiment of the present disclosure.

FIG. 2 illustrates a flow diagram representation of a method for collating articles according to an embodiment of the present disclosure.

FIG. 3 illustrates a flow diagram representation of load balancing according to an embodiment of the present disclosure.

FIG. 4a illustrates a tabular representation of logs maintained by the server in an embodiment of the present disclosure.

FIG. 4b illustrates a tabular representation of logs maintained by the server in an embodiment of the present disclosure.

FIG. 4c illustrates a tabular representation of logs maintained by the server in an embodiment of the present disclosure.

FIG. 4d illustrates a tabular representation of logs maintained by the server in an embodiment of the present disclosure.

FIG. 5 illustrates a flow diagram representation of Put to Light blinking action according to an embodiment of the present disclosure.

FIG. 6 illustrates a flow diagram representation of an article collation system according to an exemplary embodiment of the present disclosure.

### DETAILED DESCRIPTION

The following discussion provides a brief, general description of a suitable computing environment in which various embodiments of the present disclosure can be implemented. The aspects and embodiments are described in the general context of computer executable mechanisms such as routines executed by a general purpose computer e.g. a server or personal computer. The embodiments described herein can be practiced with other system configurations, including Internet appliances, hand held devices, multi-processor systems, microprocessor based or programmable consumer electronics, network PCs, mini computers, mainframe computers and the like. The embodiments can be embodied in a special purpose computer or data processor that is specifically programmed configured or constructed to perform one or more of the computer executable mechanisms explained in detail below.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures. It should be appreciated that the functions, structures, elements and the protocols used in communication are irrelevant to the present disclosure. Therefore, they need not be discussed in more detail here.

In addition, all logical units described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

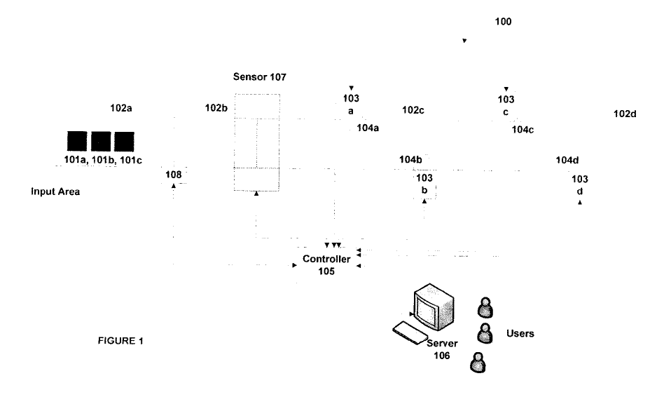

FIG. 1 of the present disclosure illustrates a general block diagram of an article collation system according to an embodiment of the present disclosure. Articles 101a, 101b, 101c are input through the input area on the system, which comprises one or more transporters 102a, 102b, 102c, 102d for moving each article along a common path to one of a plurality of collection points 103a, 103b, 103c, 103d. The transporters 102a, 102b, 102c, 102d may be a plurality of conveyor belts functioning at differential speed. Each article has an associated identifier and each identifier has associated attributes. The system further comprises a plurality of diverters 104a, 104b, 104c, 104d associated with one or more of the transporters 102a, 102b, 102c, 102d for routing each article to said collection point. The system further comprises a controller 105 to dynamically adapt operation of the transporters 102a, 102b, 102c, 102d and the diverters 104a, 104b, 104c, 104d to fulfill user requirements considering the attributes of each article and optimizing system functions based on load conditions. According to an embodiment of the present disclosure, the identifier associated with the article 101a, 101b, 101c comprises a barcode or a tag identifying the content of an article. Further, each identifier is associated with one or more attributes such as length, breadth and height of the article. The attribute may further comprise weight of the article, which may be ascertained by various mechanisms such as based on load cells.

The routing by the article collation system disclosed may be utilized at any level of combination or sortation of articles. It may be utilized at a single level or at a multi-level, which adds to the adaptability of the system disclosed. The diverters 104a, 104b, 104c, 104d are actuated only when the article on the transporter 102c, 102d is meant for respective collections points 103a, 103b, 103c, 103d. Each collection point 103a, 103b, 103c, 103d utilizes Put to Light mechanism to collate articles while using Pick Put to Light (PPTL) in an embodiment. Each PPTL is unique and has an associated barcode.

The controller 105 is coupled to a server 106, which stores a database of logs of load conditions, instantaneous and previous, for each diverter apart from a database for all orders and requirements by users. The logs may comprise identification numbers of each diverter and their associated PPTLs with their unique barcode. These logs are essential to the dynamic adaptation of operation of the system 100, which may be controlled even during its operation i.e. there is no requirement to shut the system down to reconfigure the collation performed based on load conditions. The controller 105 extracts information from the server 106 for the instantaneous load conditions as well as the previous load conditions apart from PPTL activity. The logs are utilized, as illustrated in further figures, to optimize the efficiency of the system.

An embodiment of the system additionally comprises a sensor 107 at conjunction of two conveyor belts. The sensor 107 may be a motion based sensor or an infra red sensor, to detect all articles placed on the transporter 102a, 102b,102c,102d The controller 105 controls the first transporter 102a at a speed such that each article is placed at a specific distance for effective detection by the sensor and an scanning conducted. According to an embodiment of the disclosure, the system comprises a scanner 108 controlled by the controller 105, which ascertains the length, breadth and width of the article placed and relays the information to the controller 105, which is further stored in the server 106. The scanner 108 is further configured to ascertain the weight of the article placed using volumetric measurement systems (VMS) and this information too, is stored in the server 106.

Further, the collation system 100 encompasses all aspects of an article combination and/or sortation system. In the instance, the collation system 100 operates as a combination system, articles 101a, 101b, 101c placed on the transporters 102a, 102b, 102c, 102d are combined based on user requirements and orders placed by respective users to provide a combined order. In such a scenario, the collection points 103a, 103b, 103c, 103d are specific to an order placed. The combined order is tagged in manner to identify delivery details of the order, service provider details for handling the order(s) besides any specific order handling procedure. In the instance, the system 100 operates as a sortation system; orders are sorted at a single or multi level for an organized and efficient delivery of said orders. In such a scenario, orders with tags are diverted to collection points based on delivery details of said orders or service provider details.

According to an embodiment, orders are accumulated at each collection point in a bag, where each bag has a unique seal tag placed upon sealing the bag. The collection point 103a, 103b, 103c, 103d may indicate the need to seal a bag using PPTL. The PPTL blinks upon the need to seal a bag based on instances where the bag is full with articles or the bag is required for delivery based on the special handling requirements. Upon indication of the need to close the bag, the barcode of the PPTL and the seal tag of the bag are scanned to generate a manifest indicating attributes of every article in the sealed bag. The manifest therefore, indicates any special handling requirements of the sealed bag besides the categories of the articles within the sealed bags.

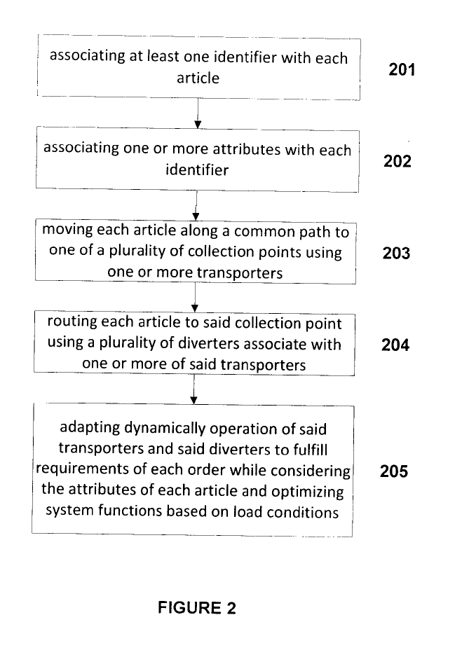

FIG. 2 illustrates a flow diagram representation of a method to collate articles according to an embodiment of the present disclosure. The method comprises associating an identifier with each article 201 and one or more attributes are associated with each identifier 202. According to embodiments, identifier comprises a barcode or a tag identifying the content of an article. Further, each identifier is associated with one or more attributes such as length, breadth and height of the article. The attribute may further comprise weight of the article, which may be ascertained by various mechanisms such as based on load cells. Each article is moved along a common path 203 to one of a plurality of collection points using one or more transporters. As disclosed in the illustration of FIG. 1, conveyor belts may be utilized as transporters, which function at differential speed. Further, each collection point comprises a plurality of Pick Put to Light (PPTL), to enable further collation of articles. The collation implemented by the method disclosed is utilized in the scenario of combination of orders or sortation of orders. The method disclosed adapts dynamically the operation 205 of the transporters and the diverters to fulfill requirements of each order while considering the attributes of each article and optimizing system functions based on load conditions.

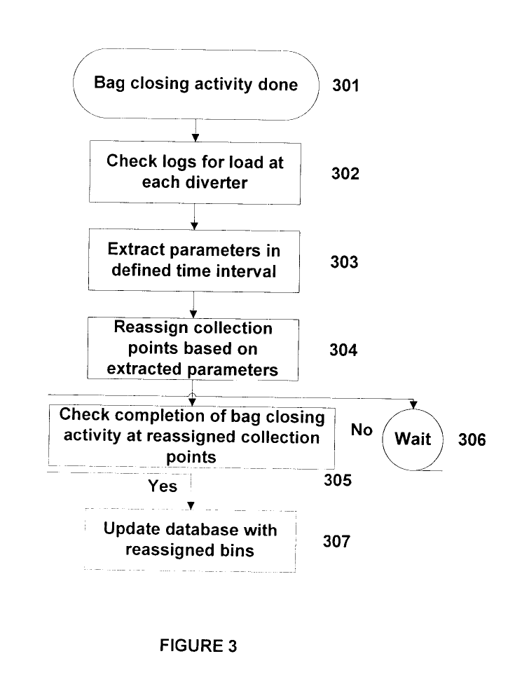

In an embodiment of the present disclosure, the method utilizes a load balancing mechanism for dynamically adapting the operation illustrated in FIG. 3. According to the embodiment, the controller 105 checks logs for load 302 at the server 106 to extract load parameters at defined time intervals 303. Based on the extracted parameters, the controller 105 ascertains the collection points to be reassigned 304 and verifies if the bag has been sealed at the reassigned collection points 305. If the bags have been sealed, the logs stored in a database at the server 106 are updated with the reassigned collection points 307, else the system waits 306 to check the log information at another time interval.

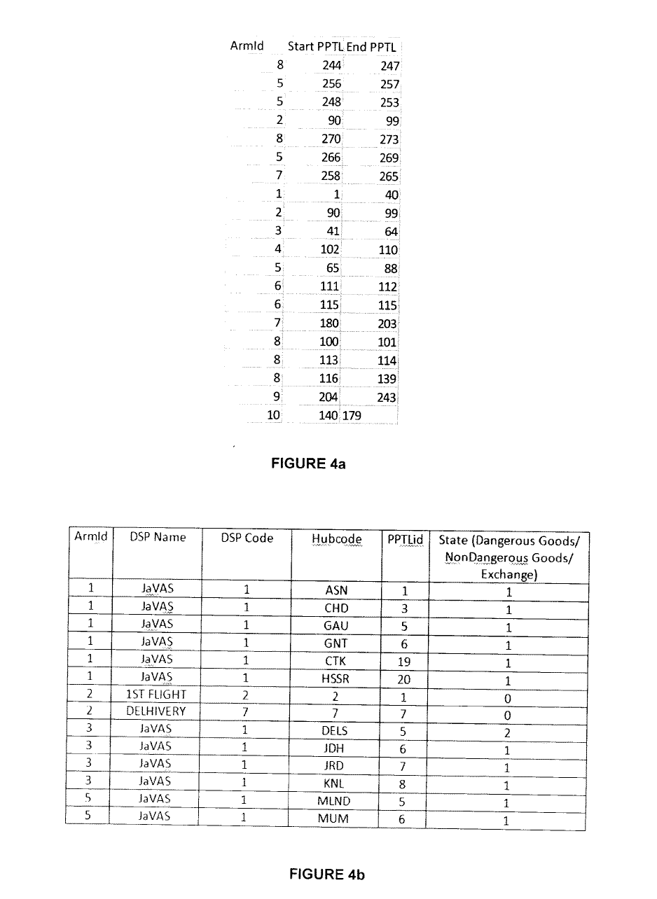

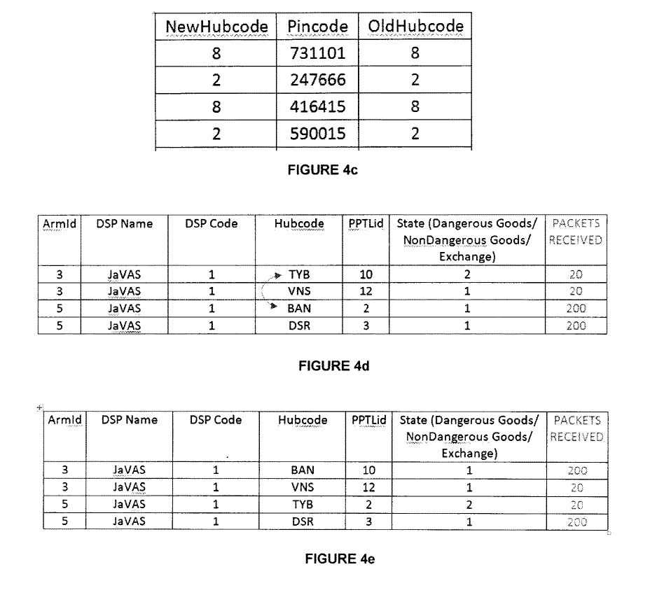

The embodiment is further illustrated vide FIGS. 4a, 4b, 4c and 4d. As referred to previously, the log of FIG. 4a, shows each diverter associated with the number of PPTLs. The log refers to ‘Armid’, which is the identity of the diverter along with its PPTL information in Start PPTL and End PPTL. Further, as illustrated in description of FIG. 1, each diverter may be associated with a service provider (DSP Name and a DSP code) and a Hubcode apart from PPTLid. The log information under FIG. 4b also refers to the state of good i.e. whether the articles being collated refer to dangerous/non-dangerous goods or articles meant for exchange. Each Hubcode is associated with a pincode, which is referenced within the attributes of each article. The log containing the Hubcode may be updated by providing references to the NewHubcode, OldHubcode and the pincode as illustrated in FIG. 4c. The controller 105 then ascertains the load conditions from the log, shown in FIG. 4d, stored in the server 106. As seen from said figure, at a defined time interval, 20 packets are received at PPTL 10 of Armid 3 while 200 packets are received at PPTL2 with Armid 5. The controller judges that there is an unproductive load distribution as Armid 5 has higher load to address. Accordingly, the controller 105 dynamically adapts PPTL10 of Armid 3 to exchange the load activity with PPTL2 of Armid 5. This exchange of load activity is done in real time and does not require shut down of the collation system. Therefore, as seen in FIG. 4e, PPTL10 of Armid 3 handles 200 packets while PPTL2 of Armid 5 handles 20 packets, and hence, the load at diverters referenced Armid 3 and Armid 5 is balanced and optimized.

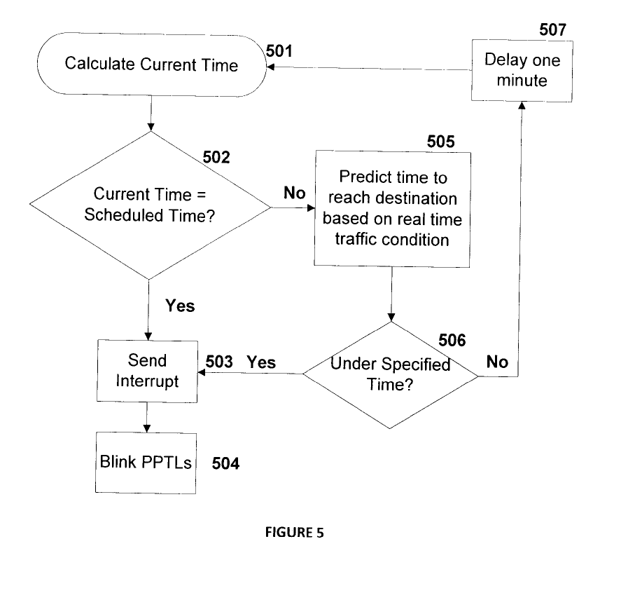

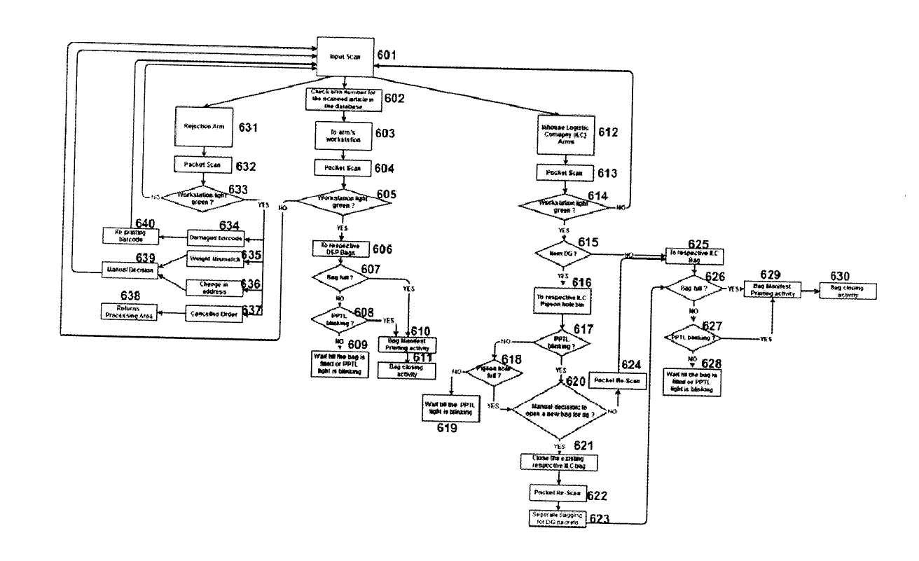

FIG. 5 of the present disclosure illustrates the operation of PPTL according to an embodiment. As illustrated previously, PPTL blinks to indicate the need to seal a bag, either when the bag is full or based on the user direction. FIG. 5 illustrates an embodiment, when the system 100 functions as a sortation system with a fixed time delivery requirement. The embodiment addresses a scenario where a truck has arrived to take articles for delivery. The embodiment calculates the current time 501 and ascertains if it is equivalent to the scheduled time 502. If they are equal, the system 100 sends an interrupt 503 in order to facilitate blinking of the PPTLs 504. However, if the current time calculated is not equivalent to the scheduled time, the time taken to reach a destination is predicted based on real time traffic condition 505. A number of known mechanisms may determine the real time traffic condition. If the predicted time is under the specified time of delivery 506, an interrupt is sent 503 to blink the PPTLs 504. However, if the predicted time is not within the specified time, a delay of one minute 507 in the calculation of current time 501 is given.

FIG. 6 of the present disclosure provides an exemplary embodiment wherein the collation system 100 is utilized under three different scenarios. According to an embodiment, the articles are scanned 601 and based on the identifier and associated attributes, the id of a particular diverter is identified by the controller 602 from the database stored in the server 106. The article moves on the common path and is diverted to the allocated collection point 603. In the instance, the collation system 100 functions as a sortation system, the diverted article is scanned again 604. If a PPTL workstation blinks (for example, it blinks green) 605, the article is placed in the respective bag 606. If the PPTL workstation does not blink, the article is scanned again at the first instance 601. During the operation of the system 100, it is determined whether the bag is full 607 or the PPTL associated with said bag is blinking 608. If it is not so, then the system waits or either situation to be fulfilled 609. However, if the bag is full or the PPTL is blinking, a bag manifest comprising information of the articles collated is printed 610 and the bag is sealed 611.

The collation system 100 is further used in In-house Logistic Company (ILC) Arms 612, where the article is scanned 613 and if a particular collection point blinks 614, it is determined whether the article is within the category of dangerous goods(DG) 615. If the article is classified as a DG, then it is forwarded to respective ILC pigeonhole collection point 616. If the PPTL associated with the pigeonhole collection point blinks 617, a manual decision is made as to whether a new bag should be placed for items under DG category 620. If the PPTL associated with the pigeonhole collection point does not blink, it is determined whether the pigeonhole is full 618. If it is, step 620 is implemented, else the system waits till PPTL blinks 619.

If a positive decision is taken for opening a new bag for items under category DG, then existing bag is closed 621 and the packet is re-scanned 622 and given a separate packaging altogether 623 as it is a DG classified article. However, if the decision is made not to open a new bag, the packet is rescanned 624 and forwarded to the respective ILC bag 625. In the event, it is ascertained that the article is classified as a DG 615, it is sent to the respective ILC bag 625. The ILC bag is checked to see whether it is full 626 and if it is, a bag manifest is printed 629 and the bag is sealed 630. However, if the bag is not full, it is determined whether the PPTL is blinking 627. If it is, then the bag is sealed 630 after printing a manifest 629 to provide information of the articles collated. However, if the PPTL is not blinking, the system waits till the bag is full or the PPTL blinks 628.

In another embodiment, the article is scanned 601, however, it is rejected 631. The rejected packet is scanned again 632 to determine whether a collection point is indicated 633 for the article. If the collection point is indicated, it is determined whether the identifier (barcode) on the article is damaged 634 and if it is, the damaged identifier (barcode) is sent for re-printing 640. It may be determined whether there is a weight mismatch 635 or change in delivery details (address) 636 for the article and in the event it is, the article is sent for a manual decision 639. In the event, it is determined that the article pertains to a cancelled order 637, the article is returned to the processing area 639.

As will be appreciated by one of skill in the art, the present invention may be embodied as a method, system, or computer program product. Accordingly, the present invention may take the form of an entirely hardware embodiment, a software embodiment or an embodiment combining software and hardware aspects all generally referred to herein as a “circuit” or “module.” Furthermore, the present invention may take the form of a computer program product on a computer-usable storage medium having computer-usable program code embodied in the medium.

Furthermore, the present invention was described in part above with reference to flowchart illustrations and/or block diagrams of methods, apparatus (systems), and computer program products according to embodiments of the invention.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

Instructions may also be loaded onto a computer or other programmable data processing apparatus like a scanner/check scanner to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and schematic diagrams of FIGS. 4-6 illustrate the architecture, functionality, and operations of some embodiments of methods, systems, and computer program products for integrated capture and analysis of documents. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation, the scope of the invention being defined by the following claims

We claim:

1. An article collation system comprising:
a. at least one identifier associated with each article;
b. one or more attributes associated with each identifier;
c. one or more transporters for moving each article along a common path to one of a plurality of collection points;
d. a plurality of diverters associated with one or more of said transporters for routing each article to said collection point; and
e. a controller dynamically adapting operation of said transporters and said diverters to fulfill user requirements considering the attributes of each article and optimizing system functions based on load conditions.

2. The system as claimed in claim 1 wherein the system comprises single level of multi level routing of each article to said collection point.

3. The system as claimed in claim 1 wherein said one or more transporters comprise of plurality of conveyor belts arranged to function at differential speed.

4. The system as claimed in claim 1 wherein said at least one identifier comprises a barcode identifying content of an article.

5. The system as claimed in claim 1 wherein said one or more attributes comprises length, breadth, height and weight of an article.

6. The system as claimed in claim 1 wherein said collection points comprise a plurality of Put to Light stations.

7. The system as claimed in claim 1 wherein said controller is coupled to a server storing logs for instantaneous and previous load conditions at each diverter.

8. The system as claimed in claim 7 wherein said controller extracts load parameters from logs stored in a server for a defined time interval.

9. The system as claimed in claim 8 wherein load parameters are such as peak load and mean load.

10. The system as claimed in claim 7 wherein said controller reassigns the collection points based on extracted parameters to dynamically adapt the operation of said transporters and diverters.

11. The system as claimed in claim 6 wherein said Put to Light stations provide a signal based on real time conditions such as flow of traffic.

12. A method for collating articles comprising:
a. associating at least one identifier with each article;
b. associating one or more attributes with each identifier;
c. moving each article along a common path to one of a plurality of collection points using one or more transporters;
d. routing each article to said collection point using a plurality of diverters associate with one or more of said transporters;
e. adapting dynamically operation of said transporters and said diverters to fulfill requirements of each order while considering the attributes of each article and optimizing the system functions based on load conditions.

13. The method as claimed in claim 12 wherein the step of routing each article to said collection point comprises a single level or multi level.

14. The method as claimed in claim 12 wherein said one or more transporters comprise of plurality of conveyor belts arranged to function at differential speed.

15. The method as claimed in claim 12 wherein said at least one identifier comprises a barcode identifying content of an article.

16. The method as claimed in claim 12 wherein said one or more attributes comprises length, breadth, height and weight of an article.

17. The method as claimed in claim 12 wherein said collection points comprise a plurality of Put to Light stations.

18. The method as claimed in claim 12 wherein adapting dynamically operation of said transporters and said diverters comprises extracting load parameters from logs stored in a server for a defined time interval.

19. The method as claimed in claim 18 wherein load parameters are such as peak load and mean load.

20. The method as claimed in claim 12 wherein adapting dynamically operation of said transporters and said diverters comprises reassigning the collection points based on extracted parameters.

21. The method as claimed in claim 17 wherein said Put to Light stations provide a signal based on real time conditions such as flow of traffic.
